(19) United States
(12) Patent Application Publication
(10) Pub. No.: US 2001/0049610 A1
(43) Pub. Date: Dec. 6, 2001

(54) Electronic medical record information management system and method thereof

(76) Inventor: Michihiro Hazumi, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/864,261

(22) Filed: May 25, 2001

(30) Foreign Application Priority Data
May 26, 2000 (JP) 161171/2000

(51) Int. Cl. G06F 17/60

(52) U.S. Cl. 705/3

(57) ABSTRACT

An electronic medical record information management system and an electronic medical record information management method, in which a medical institute such as a medical practitioner and a small hospital, which have some difficulty to introduce and operate a large electronic medical record information management system, can use, are provided. A user makes electronic medical records of patients by using an electronic medical record terminal in a hospital information system, and transmits the electronic medical records of the patients made at the electronic medical record terminal to an electronic medical record information management center system. The user requests to transmit an electronic medical record of a patient storing in the electronic medical record information management center system. A control server in the electronic medical record information management center system takes out the electronic medical record of the patient requested by the user from an electronic medical record storing server in the electronic medical record information management center system, and transmits this electronic medical record of the patient to the hospital information system. The electronic medical record terminal shows this electronic medical record of the patient to the user. The electronic medical record terminal also transmits an electronic medical terminal added new information to the electronic medical record information management center system. The control server makes the electronic medical record storing server store this electronic medical record added the new information.

### BACKGROUND OF THE INVENTION

The present invention relates to an electronic medical record information management system and a method thereof, in particular, in which a medical practitioner and a small hospital, which have some difficulty to organize introducing and operating a large electronic medical record information management system, can use an electronic medical record in high security.

### DESCRIPTION OF THE RELATED ART

Recently, it has been possible to store medical records electronically. Hereinafter, this medical record storing electronically is referred to as an electronic medical record. In order to store the medical record electronically, it is necessary to secure that the electronic medical record has authenticity, readability, and storing ability. In this, the authenticity signifies that the data in the electronic medical record are not altered, and the storing ability signifies that the data in the electronic medical record are stored almost permanently.

In order to secure the authenticity and the storing ability of the electronic medical record, the data of the electronic medical record must be managed and stored in high security. That is, it is necessary that the data in the electronic medical record are not altered and are not obtained by a person except a user being a doctor who gives a patient treatment. In order to achieve this, a large electronic medical record information management system must be introduced. Further, in order to use the electronic medical record at the time when a doctor visits a house or a place where is not inside a medical institute, a much larger electronic medical record information management system having higher security must be introduced.

However, it is actually difficult for a medical practitioner and a small hospital to introduce this large electronic medical record information management system from economic and technical points of view.

### SUMMARY OF THE INVENTION

It is therefore an object of the present invention to provide an electronic medical record information management system and a method thereof, in which a medical institute such as a medical practitioner and a small hospital, which have some difficulty to introduce and operate a large electronic medical record information management system, can use an electronic medical record in high security.

According to a first aspect of the present invention for achieving the object mentioned above, there is provided an electronic medical record information management system. The electronic medical record information management system provides an electronic medical record information managing means, and an electronic medical record showing means. And the electronic medical record information managing means stores electronic medical records of patients that are transmitted from the electronic medical record showing means every patient, and transmits one or more of the electronic medical records of the patients storing in the electronic medical record information managing means by a request transmitted from the electronic medical record showing means to the electronic medical record showing means, and the electronic medical record showing means transmits electronic medical records of patients that are made by a user to the electronic medical record information managing means, and transmits a request of the user to transmit one or more of the electronic medical records of the patients to the electronic medical record information managing means, and shows one or more of the electronic medical records of the patients transmitted from the electronic medical record information managing means to the user.

According to a second aspect of the present invention, there is provided an electronic medical record information management system. The electronic medical record information management system provides at least one of an electronic medical record information managing means, plural electronic medical record showing means, and a communication network that connects at least one of the electronic medical record information managing means to the plural electronic medical record showing means. And each of the plural electronic medical record showing means provides a first communication unit for connecting to the communication network, and at least one of a first electronic medical record terminal that makes electronic medical records of patients and transmits the electronic medical records of the patients to the electronic medical record information managing means through the first communication unit and the communication network, and makes a request of a user to transmit one or more of the electronic medical records of the patients storing in the electronic medical record information managing means, and transmits the request to the electronic medical record information managing means through the first communication unit, and shows one or more of the electronic medical records transmitted from the electronic medical record information managing means to the user. And the electronic medical record information managing means provides a second communication unit for connecting to the communication network, an electronic medical record storing server that stores the electronic medical records of the patients that were transmitted from the electronic medical record showing means, and a control server that obtains one or more of the electronic medical records storing in the electronic medical record storing server by the request of the user transmitted from the electronic medical record showing means, and transmits obtained one or more of the electronic medical records to the electronic medical record showing means through the second communication unit.

According to a third aspect of the present invention, in the second aspect, the first electronic medical record terminal further adds some information to each of the electronic medical records and transmits the electronic medical records added some information to the electronic medical record information managing means through the first communication unit, and the control server further makes the electronic medical record storing server store the electronic medical records received from the electronic medical record showing means through the second communication unit

According to a fourth aspect of the present invention, there is provided an electronic medical record information management system. The electronic medical record information management system provides at least one of an electronic medical record information managing means, plural electronic medical record showing means, and a communication network that connects at least one of the electronic medical record information managing means to the plural electronic medical record showing means. And each of the plural electronic medical record showing means provides a first communication unit for connecting to the communication network, an electronic medical record temporarily storing server that stores electronic medical records temporarily and transmits the electronic medical records to the electronic medical record information managing means through the first communication unit and receives electronic medical records from the electronic medical record information managing means through the first communication unit and stores received the electronic medical records temporarily, and at least one of a second electronic medical record terminal that makes electronic medical records of patients and transmits the electronic medical records of the patients to the electronic medical record temporarily server, and makes a request of a user to transmit one or more of the electronic medical records of the patients storing in the electronic medical record temporarily storing server, and transmits the request to the electronic medical record temporarily storing server, and shows one or more of the electronic medical records transmitted from the electronic medical record temporarily storing server to the user. And the electronic medical record temporarily storing server searches one or more of the electronic medical records requested by the second electronic medical record terminal in the electronic medical record temporarily storing server, and when one or more of the electronic medical records requested by the second electronic medical record terminal are not stored in the electronic medical record temporarily storing server, the electronic medical record temporarily storing server transmits the request to the electronic medical record information managing means through the first communication unit, and transmits one or more of the electronic medical records received from the electronic medical record information managing means through the first communication unit to the second electronic medical record terminal. And the electronic medical record information managing means provides a second communication unit for connecting to the communication network, an electronic medical record storing server that stores the electronic medical records of the patients that were transmitted from the electronic medical record showing means, and a control server that obtains one or more of the electronic medical records storing in the electronic medical record storing server by the request of the user transmitted from the electronic medical record showing means, and transmits obtained one or more of the electronic medical records to the electronic medical record showing means through the second communication unit.

According to a fifth aspect of the present invention, in the fourth aspect, the second electronic medical record terminal further adds some information to each of the electronic medical records and transmits the electronic medical records added some information to the electronic medical record temporarily storing server, the electronic medical record temporarily storing server transmits the electronic medical records received from the second electronic medical record terminal to the electronic medical record information managing means through the first communication unit after a designated time passed, and the control server further makes the electronic medical record storing server store the electronic medical records received from the electronic medical record showing means through the second communication unit

According to a sixth aspect of the present invention, in the fifth aspect, the electronic medical record temporarily storing server stores the electronic medical records until the electronic medical record information managing means stores the electronic medical records.

According to a seventh aspect of the present invention, in the fifth aspect, the control server makes the electronic medical record showing means delete the electronic medical records storing in the electronic medical record showing means after the electronic medical records were stored in the electronic medical record storing server.

According to an eighth aspect of the present invention, in the second and the fourth aspect, the control server judges whether the user who transmitted the request is a user who has a first access right or not, and when the user has the first access right, the control server obtains the electronic medical record of the patient designated by the request from the electronic medical record storing server.

According to a ninth aspect of the present invention, in the eighth aspect, the electronic medical record showing means further provides a first access right information making unit that transmits first access right information with which the control server judges whether the user has the first access right or not to the electronic medical record information managing means through the first communication unit. And the control server judges whether the user who transmitted the request is the user who has the first access right or not, based on the first access right information received from the electronic medical record showing means through the second communication unit.

According to a tenth aspect of the present invention, in the third and the fifth aspects, the control server judges whether the user who transmitted the request is a user who has a second access right or not, and when the user has the second access right, the control server makes the electronic medical record storing server store the electronic medical records.

According to an eleventh aspect of the present invention, in the tenth aspect, the electronic medical record showing means further provides a second access right information making unit that transmits second access right information with which the control server judges whether the user has the second access right or not to the electronic medical record information managing means through the first communication unit. And the control server judges whether the user who transmitted the request is the user who has the second access right or not, based on the second access right information received from the electronic medical record showing means through the second communication unit.

According to a twelfth aspect of the present invention, in the second and the fourth aspects, the electronic medical record includes original data before new data are added.

According to a thirteenth aspect of the present invention, in the second and the fourth aspects, when data are transmitted between the electronic medical record information managing means and the electronic medical record showing means, the data are encrypted and the encrypted data are transmitted, and when data are received at the electronic medical record information managing means and the electronic medical record showing means, the data are decrypted.

According to a fourteenth aspect of the present invention, in the second and the fourth aspects, the electronic medical record information managing means further provides a charging server that calculates a using charge of the electronic medical record information managing means by each of the plural electronic medical record showing means and charges the using charge to each of the plural electronic medical record showing means.

According to a fifteenth aspect of the present invention, there is provided an electronic medical record information management method. The electronic medical record information management method provides the steps of, making electronic medical records of patients by a user at a hospital information system, storing the electronic medical records made by the user in the hospital information system, transmitting the electronic medical records of the patients storing in the hospital information system to an electronic medical record information management center system, storing the transmitted electronic medical records of the patients at the electronic medical record information management center system, transmitting one or more of the electronic medical records of the patients to the hospital information system when one or more of the electronic medical records of the patients are requested by the user, storing the transmitted one or more of the electronic medical records of the patients at the hospital information system, and showing stored one or more of the electronic medical records of the patients to the user at the hospital information system.

According to a sixteenth aspect of the present invention, in the fifth aspect, the electronic medical record information management method further provides the step of, judging whether the user who requested to transmit one or more of the electronic medical records of the patients has a first access right or not. And when the user has the first access right, the requested one or more of the electronic medical records are transmitted to the hospital information system.

According to a seventeenth aspect of the present invention, in the fifteenth aspect, the electronic medical record information management method further provides the steps of; deleting the electronic medical records of the patients made and stored in the hospital information system, after the electronic medical records were transmitted to the electronic medical record information management center system, and deleting one or more of the electronic medical records transmitted and stored in the hospital information system, when a designated time passed after showing one or more of the electronic medical records to the user.

According to an eighteenth aspect of the present invention, in the fifteenth aspect, the electronic medical record information management method further provides the step of, judging whether the user who requested to transmit one or more of the electronic medical records of the patients has a second access right or not. And when the user has the second access right, the electronic medical records made and transmitted from the hospital information system are stored in the electronic medical record information management center system.

According to a nineteenth aspect of the present invention, in the fifteenth aspect, the electronic medical record information management method further provides the step of, adding new information to the electronic medical records of the patients storing in the electronic medical record information management center system from the hospital information system.

According to a twentieth aspect of the present invention, in the fifteenth aspect, the electronic medical record information management method further provides the step of; charging payment to the hospital information system for using the electronic medical record information management center system.

According to a twenty-first aspect of the present invention, in the fifteenth aspect, the electronic medical record information management method further provides the steps of; encrypting the electronic medical records when the electronic medical records are transmitted, and decrypting the electronic medical records when the electronic medical records are received.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a structure of a first embodiment of an electronic medical record information management system of the present invention;

FIG. 2 is a diagram showing a screen for user authenticating at an electronic medical record terminal in a hospital information system of the present invention;

FIG. 3 is a diagram showing a screen for selecting an electronic medical record of a specified patient at an electronic medical record terminal in the hospital information system of the present invention;

FIG. 4 is a diagram showing an electronic medical record of a patient at the present invention;

FIG. 5 is a diagram showing an electronic medical record in which new information of the patient is added at the present invention;

FIG. 6 is a diagram showing a structure of a second embodiment of the electronic medical record information management system of the present invention;

FIG. 7 is a diagram showing a structure of a third embodiment of the electronic medical record information management system of the present invention;

FIG. 8 is a flowchart showing the first electronic medical record information referring operation at an electronic medical record information management method of the present invention;

FIG. 9 is a flowchart showing the second electronic medical record information referring operation at the electronic medical record information management method of the present invention;

FIG. 10 is a flowchart showing the operation of an electronic medical record temporarily storing server of the third electronic medical record information referring operation at the electronic medical record information management method of the present invention;

FIG. 11 is a flowchart showing the third electronic medical record information referring operation at the electronic medical record information management method of the present invention;

FIG. 12 is a flowchart showing the first and second electronic medical record information inputting operation at the first embodiment of the electronic medical record information management system of the present invention; and

FIG. 13 is a flowchart showing the third and fourth electronic medical record information inputting operation at the second and third embodiments of the electronic medical record information management system of the present invention.

### DESCRIPTION OF THE PREFERRED EMBODIMENTS

Referring now to the drawings, embodiments of an electronic medical record information management system and an electronic medical record information management method of the present invention are explained in detail.

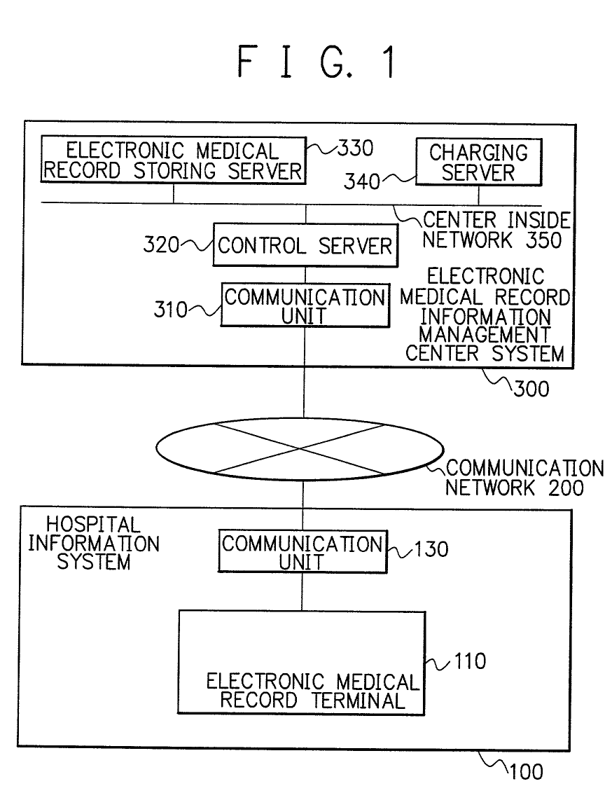

First, the embodiments of the electronic medical record information management system of the present invention are explained. FIG. 1 is a diagram showing a structure of a first embodiment of the electronic medical record information management system of the present invention. As shown in FIG. 1, the first embodiment of the electronic medical record information management system of the present invention consists of a hospital information system 100, a communication network 200, and an electronic medical record information management center system 300. The hospital information system 100 works as an electronic medical record showing means, and the electronic medical record information management center system 300 works as an electronic medical record information managing means. In FIG. 1, the number of the hospital information system 100 is one, however actually, plural hospital information systems 100 are connected to the electronic medical record information management center system 300 through the communication network 200.

The electronic medical record information management center system 300 stores electronic medical records and supplies the electronic medical records to the hospital information system 100, and also requests hospitals to pay charges for using the system. The communication network 200 electronically connects the hospital information system 100 to the electronic medical record information management center system 300. The hospital information system 100 transmits electronic medical records of patients that are made or added some information by a user (doctor) to the electronic medical record information management center system 300, and also obtains the electronic medical records of the patients from the electronic medical record information management center system 300 and shows the obtained electronic medical records to the user (doctor).

First, the electronic medical record information management center system 300 is explained. As shown in FIG. 1, the electronic medical record information management center system 300 consists of a communication unit 310, a control server 320, an electronic medical record storing server 330, a charging server 340, and a center inside network 350. In this, the electronic medical record storing server 330 and/or the charging server 340 can be installed outside the electronic medical record information management center system 300. In this case, the electronic medical record storing server 330 and/or the charging server 340 communicates with the electronic medical record information management center system 300 through the communication network 200.

If necessary, plural electronic medical record information management center systems 300 are installed, and each of the plural electronic medical record information management center systems 300 are connected through the communication network 200 or some communication network (not shown). In order to avoid that the information among the plural electronic medical record information management center systems 300 is obtained by an outside non-related person, encryption is applied to the information. And an existing technology can be used as this encryption. And when special communication lines directly connecting only the plural electronic medical record information management center systems 300 are used, this encryption is not applied to the information.

The communication unit 310 connects to the communication network 200, and transmits and receives information through the communication network 200. As the communication unit 310, any unit, with which the control server 320 can communicate the hospital information system 100 through the communication network 200, can be used, for example, a modem or a terminal adapter can be used at the case that the communication network 200 is the Internet.

The control server 320 judges whether the hospital information system 100 and/or a user (doctor), accessed the electronic medical record information management center system 300, have an access right or not. Hereinafter, this judgement is referred to as user authentication. And also the control server 320 can judge whether the hospital information system 100 and/or the user have an access right or not for an electronic medical record of a designated patient. Hereinafter, this judgement is referred to as patient authentication. At the case that this access is an access from the hospital information system 100 and/or the user that have the access right based on the judged result of the user authentication and the patient authentication, the control server 320 gives permission to the hospital information system 100 to write an electronic medical record in the electronic medical record storing server 330 or to take out an electronic medical record from the electronic medical record storing server 330.

At these user authentication and patient authentication, an access right judging table is made to judge the access right, and the control server 320 judges whether the access right exists or not by using this access right judging table, this method can be also used. In this access right judging table, at least, the patient information, the user information, and the access right information are included, and further information relating to whether a hospital information system 100 has an access right, and has an access right to access to all individual information in an electronic medical record such as all the information in the electronic medical record can be included.

The control server 320 makes the electronic medical record storing server 330 output an electronic medical record of a patient requested from a hospital information system 100 to the control server 320. The control server 320 applies an encrypting process to this electronic medical record and transmits this encrypted electronic medical record to the hospital information system 100 through the communication unit 310 and the communication network 200. An existing technology can be used for this encrypting process. And also the control server 320 decrypts the encrypted electronic medical record that was transmitted from a hospital information system 100, and makes the electronic medical record storing server 330 store this decrypted electronic medical record.

At a case that the electronic medical record information management center system 300 requests a charge to a hospital, the control server 320 informs this charging of the charging server 340. This charging process is explained later.

An access from except a predetermined hospital information system 100 can be prevented. For this, an existing technology such as a fire wall technology can be used.

The electronic medical record storing server 330 stores electronic medical records every patient. And the electronic medical record storing server 330 transmits an electronic medical record designated by a hospital information system 100 to the hospital information system 100 through the control server 320, the communication unit 310, and the communication network 200. And also the electronic medical record storing server 330 stores an electronic medical record of a patient received from a hospital information system 100 through the communication network 200, the communication unit 310, and the control server 320.

The electronic medical record should be an electronic medical record that can be prevented from altering. That is, when new information was added to the electronic medical record, the original electronic medical record before added some information must be referred.

For example, when new information is added to the electronic medical record, this electronic medical record added new information is stored in the electronic medical record storing server 330, and this newest electronic medical record is always supplied to the user.

Or the electronic medical record is stored as data, and at this case, it is decided that data inputted in the past is not changed. At the case that the data inputted in the past can be changed, the data before changed are stored as the data in the past, or the electronic medical record is stored as one data including the data before and after the change or addition. And at the hospital information system 100, only the data after changed or added new information are taken and are shown.

As mentioned above, at the case that the electronic medical records are stored every patient, the electronic medical records are managed so that an electronic medical record can be referred by only a predetermined hospital. For example, a hospital can not access to information that is made by the other hospitals or can access to only predetermined information based on a predetermined agreement between hospitals.

And also the electronic medical records can be stored every hospital and every patient. At this case, it is possible that an electronic medical record of a patient made by a hospital can be referred by other hospital in the case that the patient is the same. And also the electronic medical records can be stored every medical office in the hospital and every patient. At this case, it is possible that an electronic medical record of a patient made a medical office can be referred by other medical office in the hospital or in the other hospitals in the case that the patient is the same.

The electronic medical records storing in the electronic medical record storing server 330 can be also stored in a backup server (not shown) at a designated interval. This backup server can be installed in the electronic medical record information management center system 300 or in the outside that is connected to the electronic medical record information management center system 300 through the communication network 200. At the case that this backup server is installed in the outside, it is necessary that the information between the electronic medical record information management center system 300 and the backup server is not obtained by other parties. In order to solve this, an encrypting process is applied to the information or a special communication line only between the both sides is used.

The charging server 340 makes charging information every hospital and manages the charging information, and collects or requests the charge for using the electronic medical record information management center system 300 from the hospital, based on the charging information.

This charging information is information using for collecting or requesting the using charge. For example, this charging information is information to calculate the using charge from the number of times that a hospital used the electronic medical record information management center system 300 in a designated period, or the using charge calculated by this information. This charging information is managed every hospital and every designated period.

As a method to make the charging information, any method, in which the charging server 340 can manage the charging information every hospital in the designated period, can be used. For example, when the control server 320 executed the charging operation, the control server 320 informs this of the charging server 340. And the charging server 340 makes the charging information based on this information and manages this charging information. Or the charging server 340 monitors the operation of the control server 320, when the control server 320 executed the charging operation, and the charging server 340 makes the charging information and manages this charging information. Or one of the control server 320, the electronic medical record storing server 330, and the charging server 340 adds the number of times of the charging operation to the electronic medical records, and the charging server 340 searches the electronic medical record storing server 330 every designated period and makes the charging information every hospital and manages the charging information.

It is possible that the electronic medical record information management center decides the charging operation or decides it by an agreement between the electronic medical record information management center and the hospitals. For example, the charging is executed every access of the hospital information system 100 to the electronic medical record information management center system 300, or the charging is executed at every time that the control server 320 executes the user authentication or the patient authentication. Or the charging is executed at every time that the electronic medical record is stored in the electronic medical record storing server 330 or the electronic medical record is taken out of the electronic medical record storing server 330.

As the using charge collecting or requesting method, any method, in which the electronic medical record information management center can obtain the using charge form the hospitals, can be used.

An existing method can be used as the collecting method of the using charge. For example, the using charge is transferred to the account of the electronic medical record information management center by using electronic money, or the using charge is transferred from the account of the hospitals to the account of the electronic medical record information management center.

An existing method can be used as the requesting method of the using charge. For example, the electronic medical record information management center informs the hospital about the request of the using charge by using an e-mail. Or an image forming section (not shown) in the charging server 340 or an image forming server (not shown) connected to the electronic medical record information management center system 300 prints out a document written this request of the using charge and sends this document to the hospital. Or in addition to this document, the image forming section or the image forming server prints out a money transfer blank using at a bank and transmits this money transfer blank to the hospital, or transmits image data of this money transfer blank to the hospital information system 100.

The center inside network 350 electronically connects elements in the electronic medical record information management center system 300 with one another, and makes the elements communicate with one another. As the center inside network 350, any network, in which the elements can electronically communicate with one another, can be used, for example, a local area network (LAN) can be used.

As the communication network 200, any network, in which the electronic medical record information management center system 300 and the hospital information system 100 can be connected electronically, can be used. For example, the Internet, a wireless communication network, or a telephone line network can be used. And in the communication network 200, in order to prevent other people from obtaining the information of the electronic medical record communicating between the both systems 100 and 300, the information is encrypted and communicated. In this, when a special network, in which the other people can not obtain the information, is used as the communication network 200, the encrypting process is not applied to the information. As at the encrypting process, an existing technology can be used, for example, a symmetric key scheme or a public-key infrastructure having a secret-key and a public-key can be used.

Next, referring to FIG. 1, the hospital information system 100 is explained. As shown in FIG. 1, the hospital information system 100 consists of an electronic medical record terminal 110 and a communication unit 130.

The communication unit 130 connects to the communication network 200, and transmits and receives information through the communication network 200 and makes the electronic medical record terminal 110 connect to the electronic medical record information management center system 300 through the communication network 200. As the communication unit 130, any unit, with which the electronic medical record terminal 110 can communicate the electronic medical record information management center system 300 through the communication network 200, can be used, for example, a modem or a terminal adapter can be used at the case that the communication network 200 is the Internet.

The electronic medical record terminal 110 makes electronic medical records of patients and also makes data that are needed at the user authentication and the patient authentication at the control server 320, and transmits these electronic medical records and the data to the electronic medical record information management center system 300 through the communication unit 130. And the electronic medical record terminal 110 receives electronic medical records from the electronic medical record information management center system 300 through the communication unit 130, and shows the user the electronic medical records. And also the electronic medical record terminal 110 informs the electronic medical record information management center system 300 about added information to the electronic medical records.

As mentioned above, the user authentication and the patient authentication are executed at the control server 320 through the electronic medical record terminal 110. Therefore, it is necessary that the electronic medical record terminal 110 can input the data requiring at the user authentication and the patient authentication. And also the user authentication and/or the patient authentication can be executed an access right information making unit (not shown).

At the case that the user authentication is executed by using a user ID and a password of the user, it is necessary that the electronic medical record terminal 110 is a terminal to which the user ID and the password are inputted. And when the user authentication is executed by an ID card of the user, the electronic medical record terminal 110 takes out information stored in the ID card. Further when the user authentication is executed by a feature of a person such as a fingerprint of the user, it is necessary that the electronic medical record terminal 110 detects the feature of the user.

At the user authentication, one or more existing methods including the methods mentioned above are used. And at the patient authentication, the same method that the user authentication is executed can be used.

As mentioned above, the electronic medical record is transmitted after applied the encrypting process, therefore it is necessary that the electronic medical record terminal 110 can decrypt the encrypted electronic medical record.

As a method that the electronic medical record terminal 110 shows the electronic medical record to the user, any method can be used. For example, the electronic medical record is displayed on a display (not shown) of the electronic medical record terminal 110, or on a displaying section (not shown) connected to the electronic medical record terminal 110. Or the electronic medical record is printed out from a printer (not shown) in the electronic medical record terminal 110 or from an image forming unit (not shown) connected to the electronic medical record terminal 110. And also it is possible that the electronic medical record terminal 110 shows the information to the user by transforming the obtained information into a designated form. This designated form is a predetermined form or a form decided by the user.

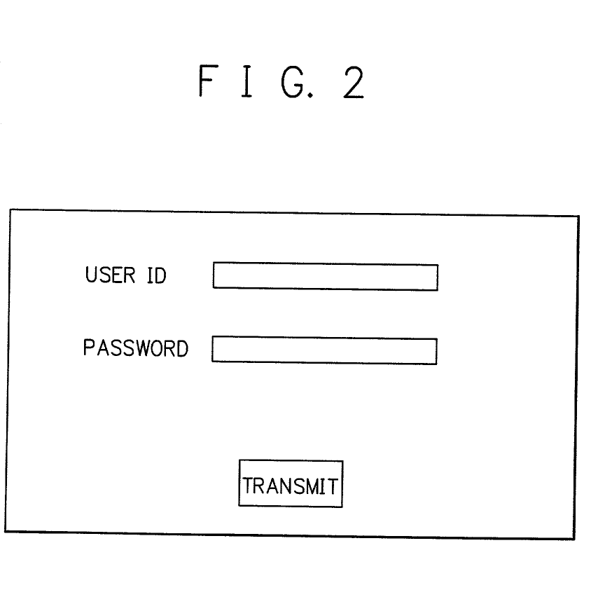

For example, when the user accesses to the electronic medical record information management center system 300 by using the electronic medical record terminal 110, a screen is shown at the electronic medical record terminal 110 by the control server 320. FIG. 2 is a diagram showing a screen for user authenticating at the electronic medical record terminal 110 in the hospital information system 100 of the present invention. When the user inputs necessary matters such as the user ID and the password of the user and transmits the data to the electronic medical record information management center system 300, the control server 320 executes the user authentication for this user.

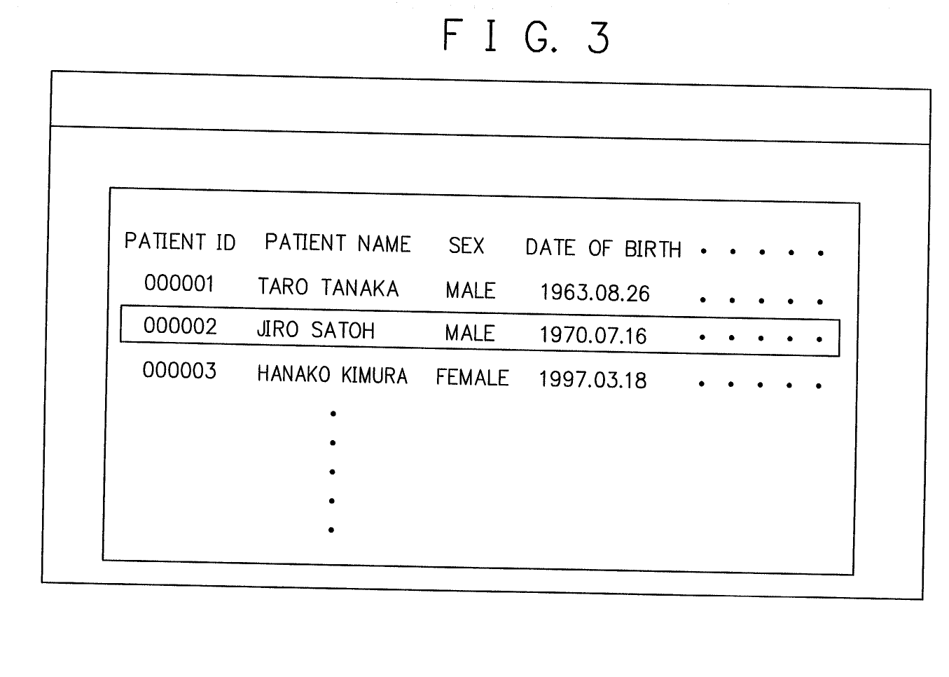

FIG. 3 is a diagram showing a screen for selecting an electronic medical record of a specified patient at the electronic medical record terminal 110 in the hospital information system 100 of the present invention. As shown in FIG. 3, the control server 320 shows a list of patients for whom the user has the access right on the electronic medical record terminal 110. The user selects a patient whose electronic medical record is required by the user on the electronic medical record terminal 110, and informs the electronic medical record information management center system 300 about this request.

In this, it is possible that the control server 320 does not show the list shown in FIG. 3 and the user inputs the name of a patient whose electronic medical record is required by using the electronic medical record terminal 110. At this time, the patient authentication can be executed at the time after the name of the patient was inputted.

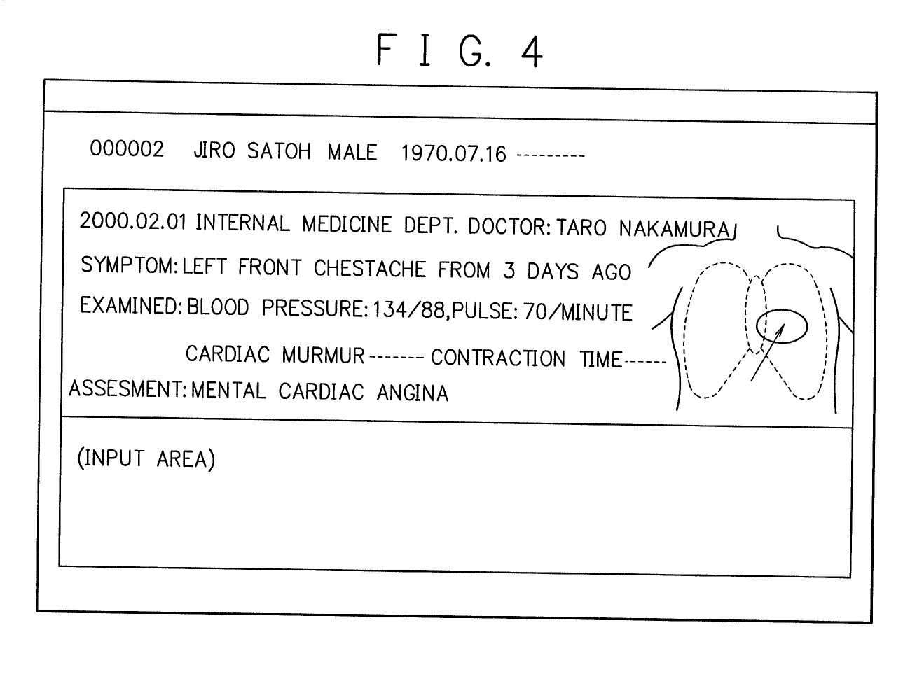

The control server 320, received this information, obtains the electronic medical record of this patient from the electronic medical record storing server 330, and transmits this obtained electronic medical record to the electronic medical record terminal 110. FIG. 4 is a diagram showing an electronic medical record of a patient at the present invention. The electronic medical record terminal 110 shows the electronic medical record of the patient shown in FIG. 4 to the user.

And the electronic medical record terminal 110 can transmit new information adding to the electronic medical record or the electronic medical record added the new information to the electronic medical record information management center system 300. At this transmission, the encrypting process is applied to the adding new information and the electronic medical record added new information. This encrypting process is executed by the existing technology mentioned above.

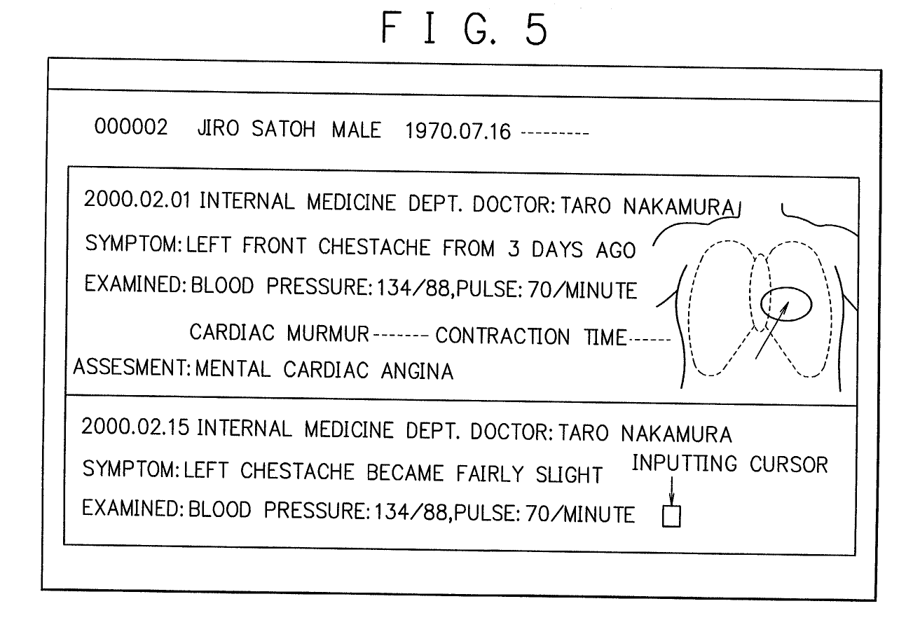

FIG. 5 is a diagram showing an electronic medical record in which new information of the patient is added at the present invention. When the user wants to add new information in the electronic medical record of the patient, the user inputs the new information in an input area of the electronic medical record shown in FIG. 4 and the electronic medical record added the new information becomes the electronic medical record shown in FIG. 5. And the electronic medical record added the new information shown in FIG. 5 is transmitted from the electronic medical record terminal 110 to the electronic medical record information management center system 300. The control server 320 makes the electronic medical record storing server 330 store this electronic medical record added the new information.

It is possible that only a specified user can use the electronic medical record 110. At this case, the user authentication is executed by the method mentioned above.

As the electronic medical record terminal 110, any terminal, which satisfies the conditions mentioned above, can be used, for example, a mobile instrument can be used. And also a mobile terminal or a facsimile having functions both of the electronic medical terminal 110 and the communication unit 130 can be used as the electronic medical terminal 110.

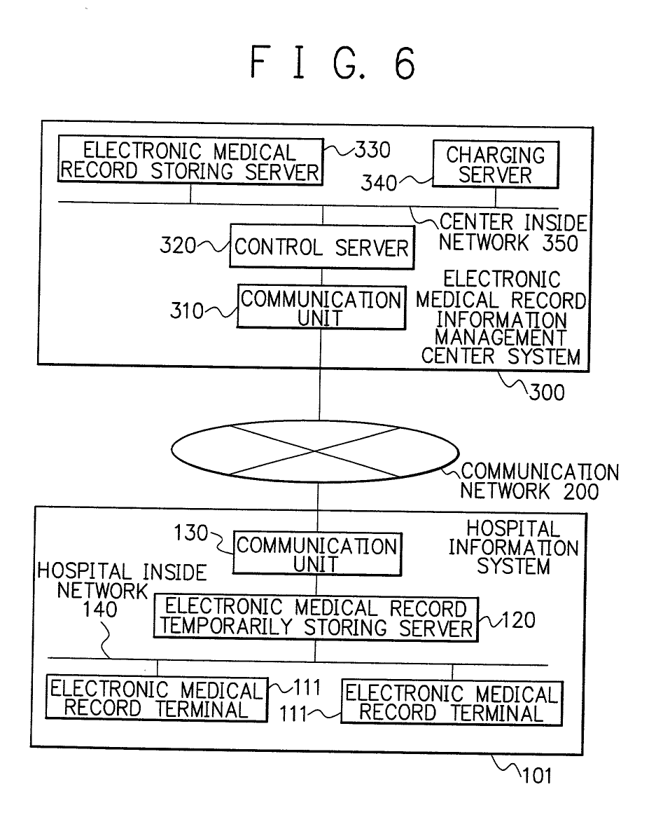

Next, a second embodiment of the electronic medical record information management system of the present invention is explained. FIG. 6 is a diagram showing a structure of the second embodiment of the electronic medical record information management system of the present invention. As shown in FIG. 6, the second embodiment of the electronic medical record information management system of the present invention consists of a hospital information system 101, a communication network 200, and an electronic medical record information management center system 300. In FIG. 6, the number of the hospital information system 101 is one, however actually, plural hospital information systems 101 are connected to the communication network 200. At the second embodiment, the communication network 200 and the electronic medical record information management center system 300 are the same that the first embodiment has, and only the hospital information system 100 at the first embodiment is replaced by the hospital information system 101. Therefore, only the hospital information system 101 is explained.

The hospital information system 101 consists of at least one of an electronic medical record terminal 111, an electronic medical record temporarily storing server 120, a communication unit 130, and a hospital inside network 140. The communication unit 130 is the same at the first embodiment. The electronic medical record terminal 111 is required to have functions that connects to the hospital inside network 140 and communicates with the electronic medical record temporarily storing server 120 and the other electronic medical record terminals 111.

The hospital inside network 140 electronically connects elements in the hospital information system 101 with one another, and makes the elements communicate with one another. As the hospital inside network 140, any network, in which the elements can electronically communicate with one another, can be used, for example, a LAN can be used.

The electronic medical record temporarily storing server 120 stores electronic medical records made at the electronic medical record terminal 111. And also the electronic medical record temporarily storing server 120 stores electronic medical records transmitted from the electronic medical record information management center system 300 for a designated period, and after the designated period passed, transmits back the electronic medical records to the electronic medical record information management center system 300. This designated period is decided to be a predetermined period passed from the electronic medical records were stored in the electronic medical record temporarily storing server 120, or a period from that the electronic medical records were received to that the user instructs to transmit back the electronic medical records. As mentioned above, when the electronic medical records are stored in the electronic medical record temporarily storing server 120, the electronic medical record terminal 111 takes out the electronic medical record from the electronic medical record temporarily storing server 120. At this time, it is possible that the user authentication is executed at the electronic medical record temporarily storing server 120. Or the user authentication is executed at the control server 320 in the electronic medical record information management center system 300, and only at the case that it is judged that the user has an access right, the electronic medical records are taken out from the electronic medical record temporarily storing server 120, this method can be also used

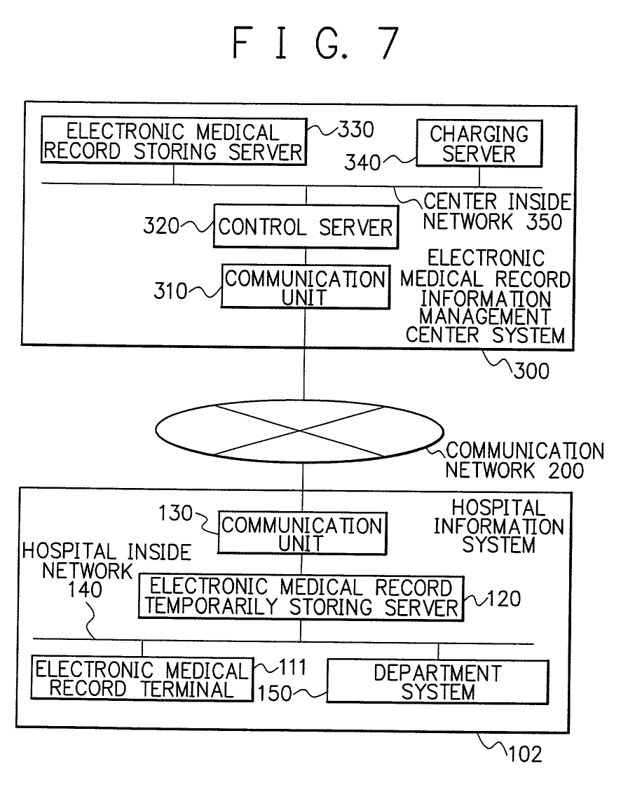

Next, a third embodiment of the electronic medical record information management system of the present invention is explained. FIG. 7 is a diagram showing a structure of the third embodiment of the electronic medical record information management system of the present invention. As shown in FIG. 7, the third embodiment of the electronic medical record information management system of the present invention consists of a hospital information system 102, a communication network 200, and an electronic medical record information management center system 300. In FIG. 7, the number of the hospital information system 102 is one, however actually, plural hospital information systems 102 are connected to the communication network 200. At the third embodiment, the communication network 200 and the electronic medical record information management center system 300 are the same that the first and second embodiments have, and only the hospital information system 102 is different from at the first and second embodiments. Therefore, only the hospital information system 102 is explained.

As shown in FIG. 7, the hospital information system 102 further provides a department system 150 compared with the hospital information system 101 at the second embodiment. In this, as the same as the first and the second embodiments, actually the plural electronic medical record terminal 111 are provided in the hospital information system 102.

The division system 150 is a system using at a hospital such as an order entry system and a medical accounting system, except the electronic medical record information management system, therefore systems using at the hospital can be installed in the hospital information system 102. New information added to the electronic medical record and using at the department system 150 is also notified to the department system 150 and is processed at the department system 150. In this case, the electronic medical record terminal 111 judges whether the new information is added to the electronic medical record or not, and at the case that the new information is added, this new information is notified to the department system 150, this method can be also used. Or the electronic medical record temporarily storing server 120 judges this addition of the new information, and the new information is notified to the department system 150, this method can be also used.

Next, referring to drawings, electronic medical record information management methods of the present invention are explained. At the electronic medical record information management methods, the hospital information system 100/101/102 obtains an electronic medical record from the electronic medical record information management center system 300, and a user adds new information to the electronic medical record at the hospital information system 100/101/102, and the electronic medical record added the new information is stored in the electronic medical record information management center system 300.

Therefore, the operation, in which the hospital information system 100/101/102 obtains the electronic medical record from the electronic medical record information management center system 300, is explained. Hereinafter, this operation is referred to as an electronic medical record information referring operation. And also the operation, in which the hospital information system 100/101/102 makes the electronic medical record information management center system 300 store the electronic medical records, is explained. Hereinafter, this operation is referred to as an electronic medical record information inputting operation.

First, the electronic medical record information referring operation is explained. At this operation, first, user authentication is executed, and when it is judged that the user has an access right based on the result of the user authentication, the electronic medical record is shown to the user.

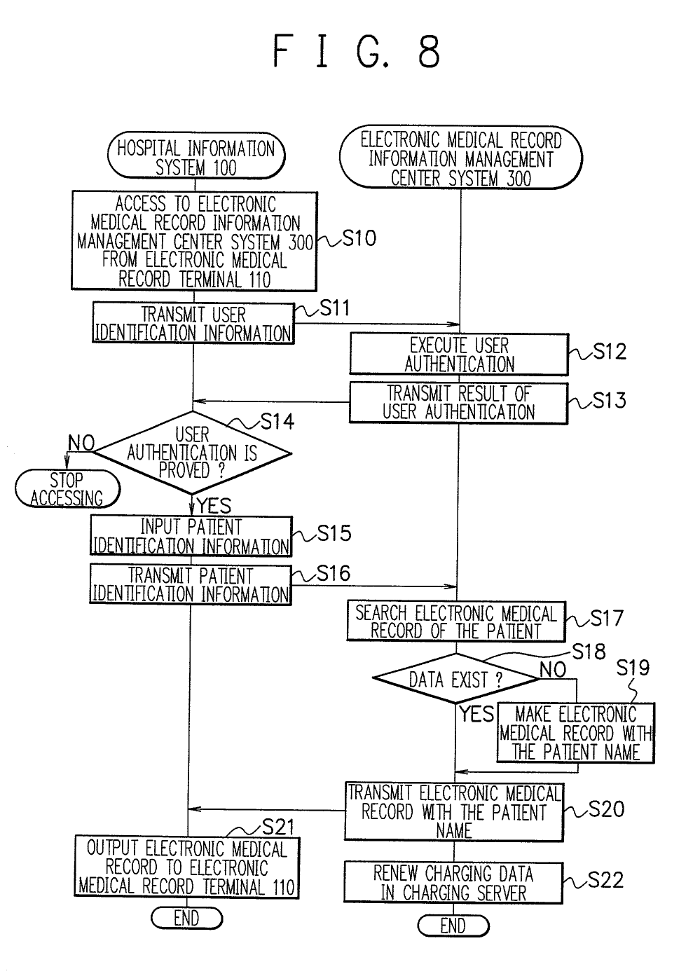

FIG. 8 is a flowchart showing the first electronic medical record information referring operation at the electronic medical record information management method of the present invention. Referring to FIGS. 1 and 8, the first electronic medical record information referring operation at the electronic medical record information management method of the present invention is explained in detail.

First, a user accesses to the electronic medical record information management center system 300 by using the electronic medical record terminal 110 in the hospital information system 100 (step S10). And the user inputs user identification information requiring to user authentication by using this electronic medical record terminal 110 and transmits this user identification information to the control server 320 in the electronic medical record information management center system 300 (step S11). The control server 320 detects this access and executes the user authentication based on this transmitted user identification information (step S12). The user authentication is executed by that the control server 320 judges whether this transmitted user identification information is matched with the data, in which the users having the access right are stored beforehand in the electronic medical record information management center system 300, by searching the stored data. The electronic medical record information management center system 300 transmits this matched result being equal or not to the electronic medical record terminal 110 (step S13). And at the electronic medical record terminal 110, it is judged whether the user authentication is proved or not, that is, the user has the access right or not based on this matched result (step S14). At the case that the user does not have the access right, that is, the user authentication is not proved (NO at the step S14), this operation is stopped in order to prevent that the data is altered. In this, it is possible that the judgement whether the user has the access right or not is executed by the control server 320 in the electronic medical record information management center system 300. And when the user does not have the access right, the control server 320 ends the communication between the electronic medical record information management center system 300 and the hospital information system 100, and the operation ends.

At the case that the user has the access right, that is, the user authentication is proved (YES at the step S14), the user inputs information, with which the electronic medical record to be transmitted from the electronic medical record information management center system 300 is specified, to the electronic medical record terminal 110 (step S15). This specified information is named as patient identification information. The user transmits this patient identification information to the electronic medical record information management center system 300 by using the electronic medical record terminal 110 (step S16). The control server 320 receives this patient identification information and informs the electronic medical record storing server 330 to transmit this electronic medical record of the specified patient. The electronic medical record storing server 330 receives this information and searches whether this electronic medical record of this patient exists or not (step S17). The electronic medical records are made at least every patient, and further the electronic medical records can be put into one group every user and/or every hospital. At the case that the electronic medical records are made every user and/or every hospital, the electronic medical record of the specified patient is searched in the electronic medical records made by the user and/or the hospital.

At the case that the electronic medical record does not exist in the electronic medical record storing server 330 at the result of the search (NO at step S18), the electronic medical record storing server 330 notifies that the electronic medical record does not exist to the control server 320. The control server 320, received this information, newly makes the electronic medical record with this patient name (step S19). In this, it is possible that the electronic medical record with this patient name is made at the electronic medical record storing server 330 and the electronic medical record storing server 330 transmits this made electronic medical record with this patient name to the control server 320.

At the case that the electronic medical record exists in the electronic medical record storing server 330 at the result of the search (YES at the step S18), the electronic medical record storing server 330 transmits this electronic medical record to the control server 320. In this, the search of this electronic medical record can be executed by using a list of the electronic medical records made beforehand (hereinafter referred to as an electronic medical record table). This electronic medical record table can be stored in the control server 320 or the electronic medical record storing server 330. And the search of the electronic medical record by using the electronic medical record table can be executed by the control server 320 or the electronic medical record storing server 330.

The control server 320 transmits this electronic medical record with the patient name to the electronic medical record terminal 110 in the hospital information system 100 (step S20). The electronic medical record terminal 110 received this electronic medical record with the patient name shows this electronic medical record to the user (step S21). And the user inputs necessary matters of the patient in the electronic medical record with the patient name. In this, the control server 320 can transmit this electronic medical record with the patient name to the electronic medical record temporarily storing server 120 in the hospital information system 101/102, and the electronic medical record terminal 111 takes out this electronic medical record with the patient name from the electronic medical record temporarily storing server 120 and shows this electronic medical record with the patient name to the user.

At the electronic medical record information management center system 300, the charging server 340 renews the charging information (step S22).

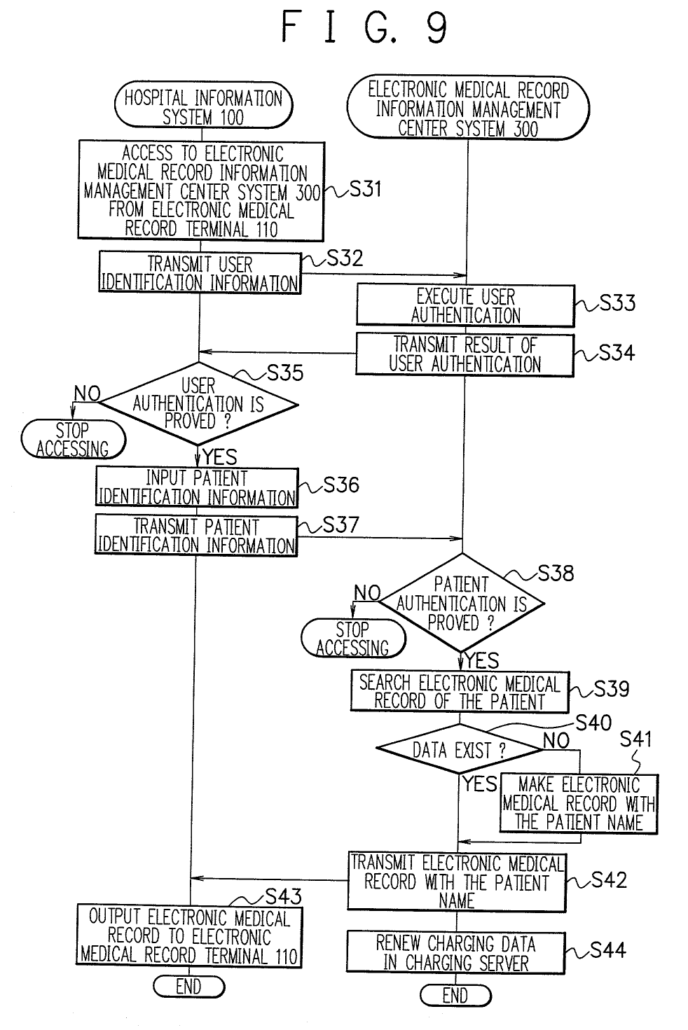

FIG. 9 is a flowchart showing the second electronic medical record information referring operation at the electronic medical record information management method of the present invention. Referring to FIGS. 1 and 9, the second electronic medical record information referring operation at the electronic medical record information management method of the present invention is explained in detail.

At the second electronic medical record information referring operation, in addition to the user authentication at the first electronic medical record information referring operation, it is judged whether the user has the access right for an electronic medical record of a patient whom the user specified or not. Hereinafter, this is referred to as patient authentication. That is, the electronic medical record of the patient is only shown to the predetermined user. As this judgment method, first, it is decided beforehand that an electronic medical record of a patient is made to correspond to a user who can obtain this electronic medical record of the patient, and it is judged whether this electronic medical record can be shown to the user or not based on the user authentication, this method is also usable. In the electronic medical record table mentioned at the first electronic medical record information referring operation, the correspondence between the user and the electronic medical records of the patients can be included. And the judgement of the patient authentication can be executed at the control server 320 or the electronic medical record storing server 330 based on the electronic medical record table.

As shown in FIG. 9, steps S31 to S37 are the same with the steps S10 to S16 in FIG. 8, and steps S39 to S44 are the same with the steps S17 to S22 in FIG. 8, and only step S38 is added to the second electronic medical record information referring operation compared with the first electronic medical record information referring operation. That is, at the case that the user has the access right, that is, the user authentication is proved (YES at the step S35), the user inputs information, with which the electronic medical record to be transmitted from the electronic medical record information management center system 300 is specified, to the electronic medical record terminal 110 (step S36). This specified information is named as patient identification information. The user transmits this patient identification information to the electronic medical record information management center system 300 by using the electronic medical record terminal 110 (step S37). After this, the patient authentication is executed at the control server 320 (step the S38). At the case that the user does not have the access right to the electronic medical record that is designated by the user at the result of the patient authentication (NO at the step S38), in order to prevent that the data are altered, the control server 320 does not transmit this electronic medical record to the hospital information system 100, and ends the operation. At the case that the patient authentication is proved (YES at the step S38), the electronic medical record storing server 330 searches this electronic medical record of this patient (step the S39). And the steps are continued.

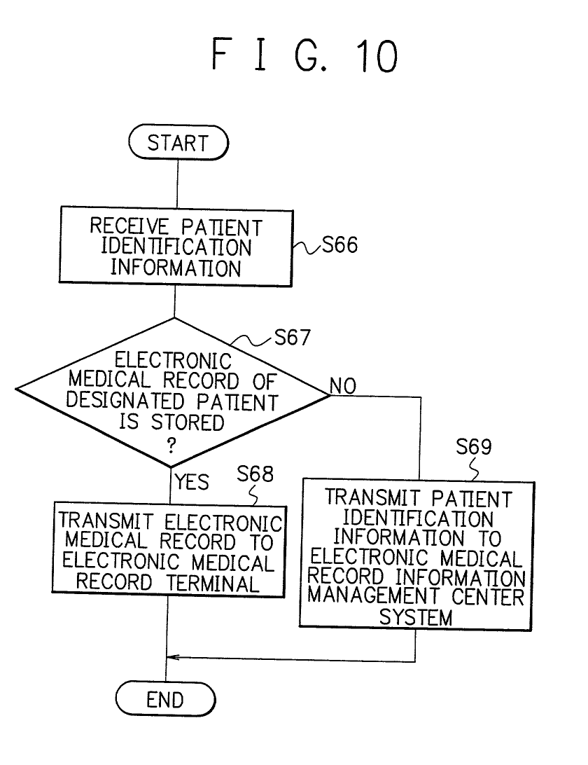

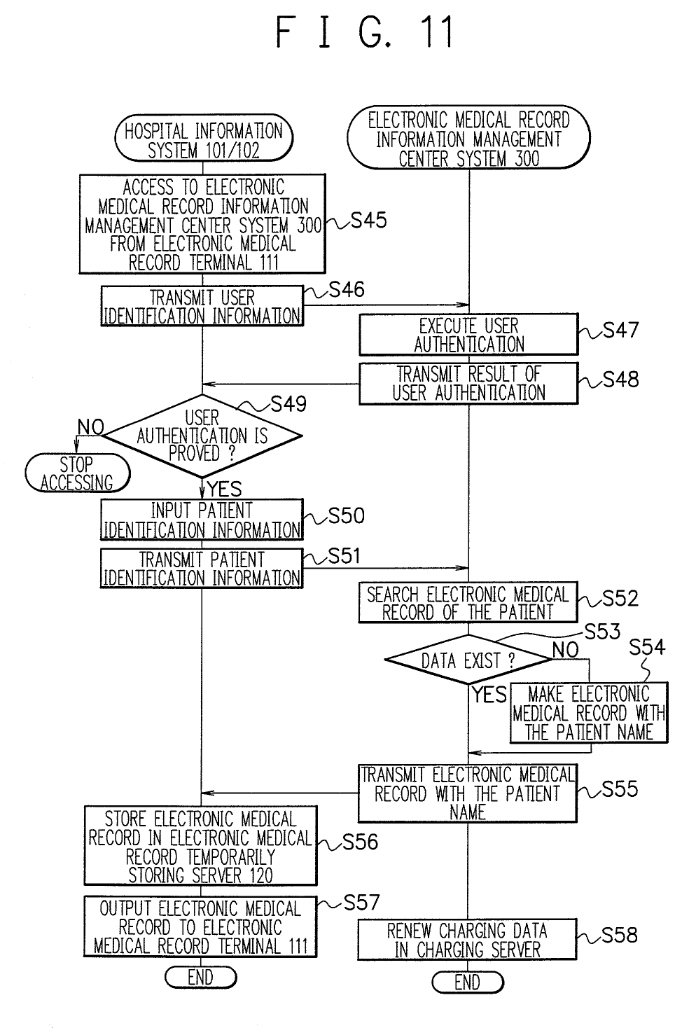

FIG. 10 is a flowchart showing the operation of the electronic medical record temporarily storing server 120 of the third electronic medical record information referring operation at the electronic medical record information management method of the present invention. FIG. 11 is a flowchart showing the third electronic medical record information referring operation at the electronic medical record information management method of the present invention. Referring to FIGS. 6,7, 10 and 11, the third electronic medical record information referring operation at the electronic medical record information management method of the present invention is explained in detail.

The third electronic medical record information referring operation is the operation at the second and third embodiment of the electronic medical record information management system shown in FIGS. 6 and 7, that is, the hospital information system 101/102 has the electronic medical record temporarily storing server 120. As shown in FIG. 11, steps S45 to S55 and steps S57 and S58 are the same with the steps S10 to S20 and the steps S21 and S22 at the first electronic medical record information referring operation shown in FIG. 8, however the hospital information system 100 is replaced by the hospital information system 101/102, and the electronic medical record terminal 110 is replaced by the electronic medical record terminal 111. And a step S56 is newly added to the flowchart shown in FIG. 8.

First, as shown in FIG. 10, the electronic medical record temporarily storing server 120 receives the patient identification information from the electronic medical terminal 111 (step S66). The electronic medical record temporarily storing server 120 searches whether the electronic medical record designated by this patient identification information is stored or not (step S67). At the case that this electronic medical record is stored in the electronic medical record temporarily storing server 120 (YES at the step S67), the electronic medical record temporarily storing server 120 transmits this electronic medical record to the electronic medical record terminal 111 (step S68). At the case that this electronic medical record is not stored in the electronic medical record temporarily storing server 120 (NO at the step S67), the electronic medical record temporarily storing server 120 transmits this patient identification information to the electronic medical record information management center system 300 through the communication unit 130 (step S69). Therefore, at the step S51, the patient identification information is transmitted from the electronic medical record temporarily storing server 120. The control server 320 received this patient identification information executes the electronic medical record information referring operation shown in the steps S52 to S55 being the same as the steps S17 to S20 at the first electronic medical record information referring operation, and transmits this electronic medical record to the electronic medical record temporarily storing server 120 in the hospital information system 101/102, and the electronic medical record temporarily storing server 120 stores the electronic medical record (step S56).

Next, a fourth electronic medical record information referring operation is explained. The fourth electronic medical record information referring operation is the operation at the case that the hospital information system 101/102 has the electronic medical record temporarily storing server 120 and the patient authentication is executed in addition to the user authentication.

At the fourth electronic medical record information referring operation, the electronic medical record temporarily storing server 120 executes the patient authentication being whether the user, who transmitted the patient identification information from the electronic medical record terminal 111, has the access right to the electronic medical record of the patient designated by the user authentication and/or the patient identification information. The user authentication and the patient authentication are executed at the operation mentioned above. At the case that the patient identification information is transmitted from the user who has the access right based on the result of the authentication, the third electronic medical record information referring operation is executed. At the case that the patient identification information is transmitted from the user who does not have the access right, in order to prevent that the data are altered, the operation ends.

Next, a fifth electronic medical record information referring operation is explained. The fifth electronic medical record information referring operation is the operation at the case that the hospital information system 101/102 has the electronic medical record temporarily storing server 120 and the patient authentication is executed in addition to the user authentication at the control server 320.

At the fifth electronic medical record information referring operation, the control server 320 executes the patient authentication being whether the user, who transmitted the patient identification information from the electronic medical record terminal 111, has the access right to the electronic medical record of the patient designated by the user authentication and/or the patient identification information. The user authentication and the patient authentication are executed at the control server 320 as mentioned above. At the case that the patient identification information is transmitted from the user who has the access right based on the result of the authentication, the electronic medical record temporarily sever 120 executes the third electronic medical record information referring operation. At the case that the patient identification information is transmitted from the user who does not have the access right, in order to prevent that the data are altered, the operation ends.

Next, referring to drawings, the electronic medical record information inputting operation is explained. The electronic medical record information inputting operation signifies that a user inputs an electronic medical record of a patient and adds some information to the electronic medical record and makes the electronic medical record information management center system 300 store the electronic medical record.

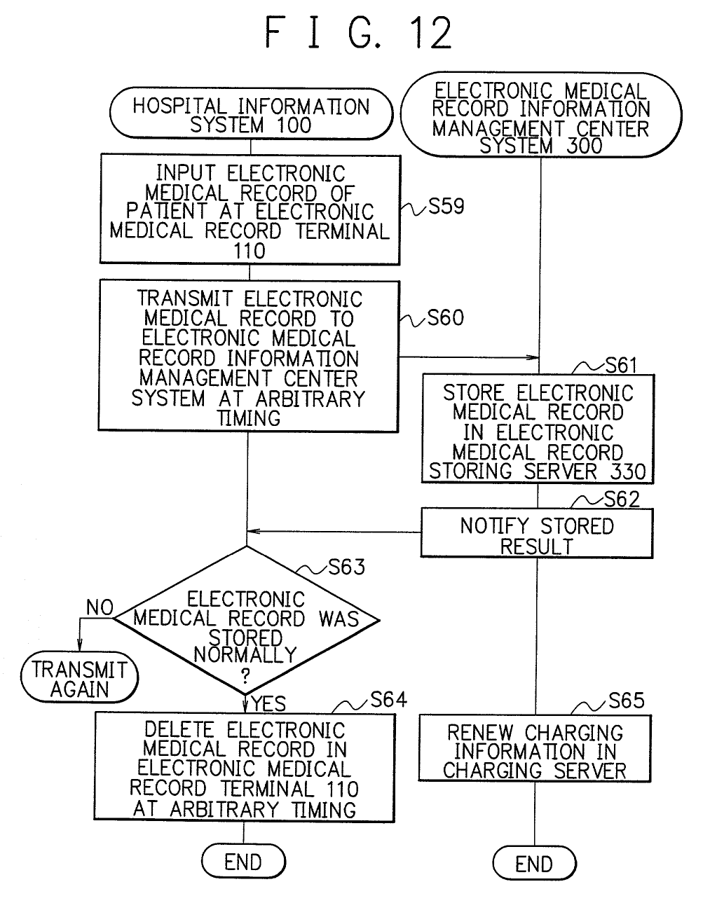

FIG. 12 is a flowchart showing the first and second electronic medical record information inputting operation at the first embodiment of the electronic medical record information management system of the present invention. Referring to FIGS. 1 and 12, the first electronic medical record information inputting operation is explained in detail. First, a user inputs information of a patient to an electronic medical record at the electronic medical record terminal 110 (step S59), and transmits the electronic medical record to the electronic medical record information management center system 300 at arbitrary timing (step S60). The control server 320 makes the electronic medical record storing server 330 store this electronic medical record (step S61).

The control server 320 can confirm whether this electronic medical record was stored in the electronic medical record storing server 330 or not. The control server 320 transmits the notification whether the electronic medical record was stored in the electronic medical record storing server 330 or not to the hospital information system 100 (step S62). This notification is the stored result notification. At the hospital information system 100, it is judged whether the electronic medical record was normally stored or not (step S63). When the electronic medical record terminal 110 receives the stored result notification that the electronic medical record was not stored (NO at the step S63), the electronic medical record terminal 110 transmits again the electronic medical record having in the electronic medical record terminal 110 to the electronic medical record information management center system 300. The control server 320, received the electronic medical record that was transmitted again, makes the electronic medical record storing server 330 store this electronic medical record. When the electronic medical record terminal 110 receives the stored result notification that the electronic medical record was normally stored (YES at the step S63), the electronic medical record terminal 110 deletes the electronic medical record that is in the electronic medical record terminal 110 at arbitrary timing (step S64). After the electronic medical record was stored in the electronic medical record storing server 330, the electronic medical record information management center system 300 renews the charging information (step S65).

Next, the second electronic medical record information inputting operation is explained. At the second electronic medical record information inputting operation, in order to prevent that the data of the electronic medical records are altered, the user authentication and/or the patient authentication are executed before the first electronic medical record information inputting operation is executed. The user authentication and/or patient authentication are executed by the method mentioned above. And only when the control server 320 judged that the user had the access right to the electronic medical record of the patient based on the result of the authentication, the first electronic medical record information inputting operation is executed.

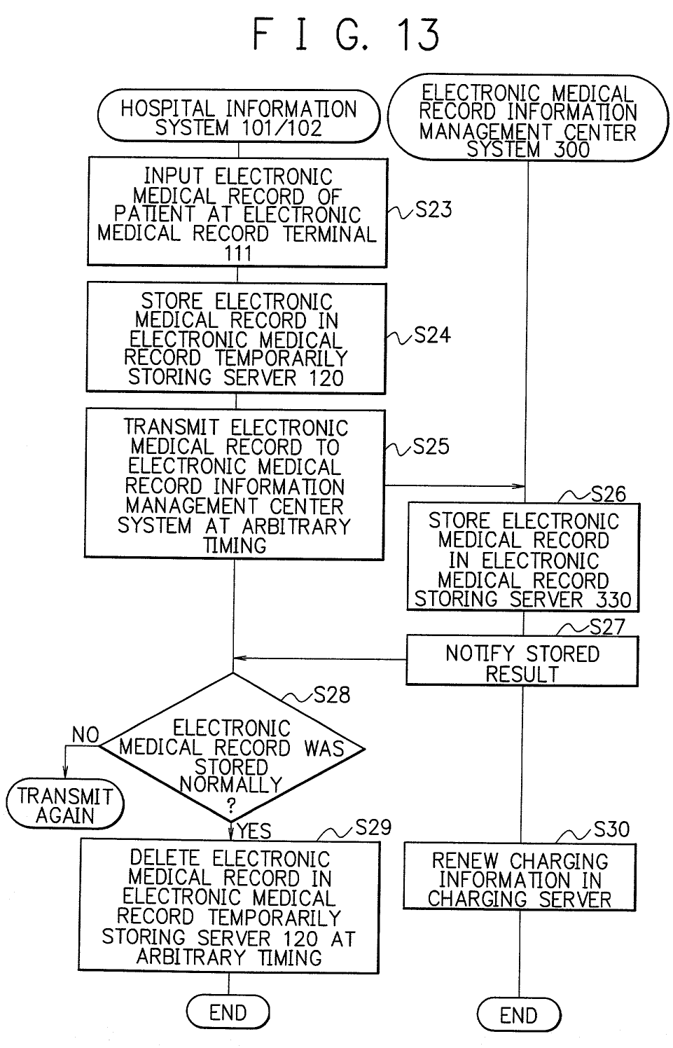

FIG. 13 is a flowchart showing the third and fourth electronic medical record information inputting operation at the second and third embodiments of the electronic medical record information management system of the present invention. First, referring to FIGS. 6, 7, and 13, the third electronic medical record information inputting operation is explained. First, a user inputs information of a patient to an electronic medical record at the electronic medical record terminal 111 (step S23), and makes the electronic medical record temporarily storing server 120 store this electronic medical record (step S24). The electronic medical record temporarily server 120 transmits this electronic medical record to the electronic medical record information management center system 300 at arbitrary timing (step S25). The control server 320 makes the electronic medical record storing server 330 store this electronic medical record (step S26). In this, this arbitrary timing can be decided as timing that a predetermined period passed from that the electronic medical record was stored in the electronic medical record temporarily storing server 120, or timing that is instructed by the user.

The control server 320 can confirm whether this electronic medical record was stored in the electronic medical record storing server 330 or not. The control server 320 transmits the stored result notification to the hospital information system 101/102 (step S27). At the hospital information system 101/102, it is judged whether the electronic medical record was normally store or not (step S28). When the electronic medical record temporarily storing server 120 receives the stored result notification that the electronic medical record was not stored (NO at the step S28), the electronic medical record temporarily storing server 120 transmits again the electronic medical record having in the electronic medical record temporarily storing server 120 to the electronic medical record information management center system 300. The control server 320, received the electronic medical record that was transmitted again, makes the electronic medical record storing server 330 store the electronic medical record. When the electronic medical record temporarily storing server 120 receives the stored result notification that the electronic medical record was stored (YES at the step S28), the electronic medical record temporarily storing server 120 deletes the electronic medical record that is in the electronic medical record temporarily storing server 120 at arbitrary timing (step S29). And also the electronic medical record terminal 111 deletes the electronic medical record in the electronic medical record terminal 111. After the electronic medical record was stored in the electronic medical record storing server 330, the electronic medical record information management center system 300 renews the charging information (step S30).

Next, the fourth electronic medical record information inputting operation is explained. At the fourth electronic medical record information inputting operation, in order to prevent that the data of the electronic medical records are altered, the user authentication and/or the patient authentication are executed before the third electronic medical record information inputting operation is executed. The user authentication and/or patient authentication are executed by the method mentioned above. And only when the control server 320 judged that the user had the access right to the electronic medical record of the patient based on the result of the authentication, the third electronic medical record information inputting operation is executed.

Next, the charging information making operation is explained. The hospital information system 100/101/102 pays its using charge when the hospital information system 100/101/102 uses the electronic medical record information management center system 300. In order to request this using charge to hospitals, the electronic medical record information management center system 300 makes charging information. Therefore, the operation, in which the charging server 340 in the electronic medical record information management center system 300 makes the charging information, is explained. This operation is the charging information making operation.

First, the first charging information making operation is explained. The charging server 340 monitors whether the charging operation of the hospital information system 100/101/102 is executed or not at the control server 320. When it is confirmed that the charging operation was executed at the control server 320 based on the monitored result, the charging server 340 adds information, which the charging operation was executed, to each of the charging information of the hospitals.

Next, the second charging information making operation is explained. When the charging operation was executed, the control server 320 notifies this to the charging server 340. The charging server 340, received this information, adds information, which the charging operation was executed, to each of the charging information of the hospital.

Last, the third charging information making operation is explained. When the charging operation was executed, the control server 320 adds information, which the charging operation was executed, to each of the electronic medical records. This operation can be executed by the charging server 340, or the electronic medical record storing server 330. The charging server 340 refers charging information in the electronic medical records storing in the electronic medical record storing server 330 and makes the charging information every hospital.

As mentioned above, according to the present invention, it is not necessary that each hospital (user) stores electronic medical records of patients. Therefore, even a user, who is difficult to introduce his/her own electronic medical record information management system, can use the electronic medical records.

Further, according to the present invention, when a user has at least an electronic medical record terminal and a communication unit, the user can use electronic medical records. Therefore, even when the user (doctor) visits a house, the user can use the electronic medical record.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An electronic medical record information management system, comprising:
an electronic medical record information managing means; and
an electronic medical record showing means, wherein:
said electronic medical record information managing means stores electronic medical records of patients that are transmitted from said electronic medical record showing means every patient, and transmits one or more of said electronic medical records of said patients storing in said electronic medical record information managing means by a request transmitted from said electronic medical record showing means to said electronic medical record showing means, and
said electronic medical record showing means transmits electronic medical records of patients that are made by a user to said electronic medical record information managing means, and transmits a request of said user to transmit one or more of said electronic medical records of said patients to said electronic medical record information managing means, and shows one or more of said electronic medical records of said patients transmitted from said electronic medical record information managing means to said user.

2. An electronic medical record information management system, comprising:
at least one of an electronic medical record information managing means;
plural electronic medical record showing means; and
a communication network that connects at least one of said electronic medical record information managing means to said plural electronic medical record showing means, wherein:
each of said plural electronic medical record showing means, comprising:
a first communication unit for connecting to said communication network; and
at least one of a first electronic medical record terminal that makes electronic medical records of patients and transmits said electronic medical records of said patients to said electronic medical record information managing means through said first communication unit and said communication network, and makes a request of a user to transmit one or more of said electronic medical records of said patients storing in said electronic medical record information managing means, and transmits said request to said electronic medical record information managing means through said first communication unit, and shows one or more of said electronic medical records transmitted from said electronic medical record information managing means to said user, and
said electronic medical record information managing means, comprising:
a second communication unit for connecting to said communication network;
an electronic medical record storing server that stores said electronic medical records of said patients that were transmitted from said electronic medical record showing means; and
a control server that obtains one or more of said electronic medical records storing in said electronic medical record storing server by said request of said user transmitted from said electronic medical record showing means, and transmits obtained one or more of said electronic medical records to said electronic medical record showing means through said second communication unit.

3. An electronic medical record information management system in accordance with claim 2, wherein:
said first electronic medical record terminal further adds some information to each of said electronic medical records and transmits said electronic medical records added some information to said electronic medical record information managing means through said first communication unit, and
said control server further makes said electronic medical record storing server store said electronic medical records received from said electronic medical record showing means through said second communication unit.

4. An electronic medical record information management system, comprising.
at least one of an electronic medical record information managing means;
plural electronic medical record showing means; and
a communication network that connects at least one of said electronic medical record information managing means to said plural electronic medical record showing means, wherein:
each of said plural electronic medical record showing means, comprising:
a first communication unit for connecting to said communication network;
an electronic medical record temporarily storing server that stores electronic medical records temporarily and transmits said electronic medical records to said electronic medical record information managing means through said first communication unit and receives electronic medical records from said electronic medical record information managing means through said first communication unit and stores received said electronic medical records temporarily; and
at least one of a second electronic medical record terminal that makes electronic medical records of patients and transmits said electronic medical records of said patients to said electronic medical record temporarily server, and makes a request of a user to transmit one or more of said electronic medical records of said patients storing in said electronic medical record temporarily storing server, and transmits said request to said electronic medical record temporarily storing server, and shows one or more of said electronic medical records transmitted from said electronic medical record temporarily storing server to said user, wherein:
said electronic medical record temporarily storing server searches one or more of said electronic medical records requested by said second electronic medical record terminal in said electronic medical record temporarily storing server, and
when one or more of said electronic medical records requested by said second electronic medical record terminal are not stored in said electronic medical record temporarily storing server, said electronic medical record temporarily storing server transmits said request to said electronic medical record information managing means through said first communication unit, and transmits one or more of said electronic medical records received from said electronic medical record information managing means through said first communication unit to said second electronic medical record terminal, and
said electronic medical record information managing means, comprising:
a second communication unit for connecting to said communication network;
an electronic medical record storing server that stores said electronic medical records of said patients that were transmitted from said electronic medical record showing means; and
a control server that obtains one or more of said electronic medical records storing in said electronic medical record storing server by said request of said user transmitted from said electronic medical record showing means, and transmits obtained one or more of said electronic medical records to said electronic medical record showing means through said second communication unit.

5. An electronic medical record information management system in accordance with claim 4, wherein:
said second electronic medical record terminal further adds some information to each of said electronic medical records and transmits said electronic medical records added some information to said electronic medical record temporarily storing server,
said electronic medical record temporarily storing server transmits said electronic medical records received from said second electronic medical record terminal to said electronic medical record information managing means through said first communication unit after a designated time passed, and
said control server further makes said electronic medical record storing server store said electronic medical records received from said electronic medical record showing means through said second communication unit.

6. An electronic medical record information management system in accordance with claim 5, wherein:
said electronic medical record temporarily storing server stores said electronic medical records until said electronic medical record information managing means stores said electronic medical records.

7. An electronic medical record information management system in accordance with claim 5, wherein:
said control server makes said electronic medical record showing means delete said electronic medical records storing in said electronic medical record showing means after said electronic medical records were stored in said electronic medical record storing server.

8. An electronic medical record information management system in accordance with claim 2, wherein:
said control server judges whether said user who transmitted said request is a user who has a first access right or not, and when said user has said first access right, said control server obtains said electronic medical record of said patient designated by said request from said electronic medical record storing server.

9. An electronic medical record information management system in accordance with claim 4, wherein:
said control server judges whether said user who transmitted said request is a user who has a first access right or not, and when said user has said first access right, said control server obtains said electronic medical record of said patient designated by said request from said electronic medical record storing server.

10. An electronic medical record information management system in accordance with claim 8, wherein:
said electronic medical record showing means, further comprising:
a first access right information making unit that transmits first access right information with which said control server judges whether said user has said first access right or not to said electronic medical record information managing means through said first communication unit, wherein:
said control server judges whether said user who transmitted said request is said user who has said first access right or not, based on said first access right information received from said electronic medical record showing means through said second communication unit.

11. An electronic medical record information management system in accordance with claim 9, wherein:
said electronic medical record showing means, further comprising:
a first access right information making unit that transmits first access right information with which said control server judges whether said user has said first access right or not to said electronic medical record information managing means through said first communication unit, wherein:
said control server judges whether said user who transmitted said request is said user who has said first access right or not, based on said first access right information received from said electronic medical record showing means through said second communication unit.

12. An electronic medical record information management system in accordance with claim 3, wherein:
said control server judges whether said user who transmitted said request is a user who has a second access right or not, and when said user has said second access right, said control server makes said electronic medical record storing server store said electronic medical records.

13. An electronic medical record information management system in accordance with claim 5, wherein:
said control server judges whether said user who transmitted said request is a user who has a second access right or not, and when said user has said second access right, said control server makes said electronic medical record storing server store said electronic medical records.

14. An electronic medical record information management system in accordance with claim 12, wherein:
said electronic medical record showing means, further comprising:
a second access right information making unit that transmits second access right information with which said control server judges whether said user has said second access right or not to said electronic medical record information managing means through said first communication unit, wherein:
said control server judges whether said user who transmitted said request is said user who has said second access right or not, based on said second access right information received from said electronic medical record showing means through said second communication unit.

15. An electronic medical record information management system in accordance with claim 13, wherein:
said electronic medical record showing means, further comprising:
a second access right information making unit that transmits second access right information with which said control server judges whether said user has said second access right or not to said electronic medical record information managing means through said first communication unit, wherein:
said control server judges whether said user who transmitted said request is said user who has said second access right or not, based on said second access right information received from said electronic medical record showing means through said second communication unit.

16. An electronic medical record information management system in accordance with claim 2, wherein:
said electronic medical record includes original data before new data are added.

17. An electronic medical record information management system in accordance with claim 4, wherein:
said electronic medical record includes original data before new data are added.

18. An electronic medical record information management system in accordance with claim 2, wherein:
when data are transmitted between said electronic medical record information managing means and said electronic medical record showing means, said data are encrypted and said encrypted data are transmitted, and
when data are received at said electronic medical record information managing means and said electronic medical record showing means, said data are decrypted.

19. An electronic medical record information management system in accordance with claim 4, wherein:
when data are transmitted between said electronic medical record information managing means and said electronic medical record showing means, said data are encrypted and said encrypted data are transmitted, and
when data are received at said electronic medical record information managing means and said electronic medical record showing means, said data are decrypted.

20. An electronic medical record information management system in accordance with claim 2, wherein:
said electronic medical record information managing means, further comprising:
a charging server that calculates a using charge of said electronic medical record information managing means by each of said plural electronic medical record showing means and charges said using charge to each of said plural electronic medical record showing means.

21. An electronic medical record information management system in accordance with claim 4, wherein:
said electronic medical record information managing means, further comprising:
a charging server that calculates a using charge of said electronic medical record information managing means by each of said plural electronic medical record showing means and charges said using charge to each of said plural electronic medical record showing means.

22. An electronic medical record information management method, comprising the steps of:
making electronic medical records of patients by a user at a hospital information system;
storing said electronic medical records made by said user in said hospital information system;
transmitting said electronic medical records of said patients storing in said hospital information system to an electronic medical record information management center system;
storing said transmitted electronic medical records of said patients at said electronic medical record information management center system;
transmitting one or more of said electronic medical records of said patients to said hospital information system when one or more of said electronic medical records of said patients are requested by said user;
storing said transmitted one or more of said electronic medical records of said patients at said hospital information system; and
showing stored one or more of said electronic medical records of said patients to said user at said hospital information system.

23. An electronic medical record information management method in accordance with claim 22, further comprising the step of:
judging whether said user who requested to transmit one or more of said electronic medical records of said patients has a first access right or not, wherein:
when said user has said first access right, said requested one or more of said electronic medical records are transmitted to said hospital information system.

24. An electronic medical record information management method in accordance with claim 22, further comprising the steps of:
deleting said electronic medical records of said patients made and stored in said hospital information system, after said electronic medical records were transmitted to said electronic medical record information management center system; and
deleting one or more of said electronic medical records transmitted and stored in said hospital information system, when a designated time passed after showing one or more of said electronic medical records to said user.

25. An electronic medical record information management method in accordance with claim 22, further comprising the step of:
judging whether said user who requested to transmit one or more of said electronic medical records of said patients has a second access right or not, wherein:
when said user has said second access right, said electronic medical records made and transmitted from said hospital information system are stored in said electronic medical record information management center system.

26. An electronic medical record information management method in accordance with claim 22, further comprising the step of:
adding new information to said electronic medical records of said patients storing in said electronic medical record information management center system from said hospital information system.

27. An electronic medical record information management method in accordance with claim 22, further comprising the step of:
charging payment to said hospital information system for using said electronic medical record information management center system.

28. An electronic medical record information management method in accordance with claim 22, further comprising the steps of:
encrypting said electronic medical records when said electronic medical records are transmitted; and
decrypting said electronic medical records when said electronic medical records are received.
